(19) United States
(12) Patent Application Publication
(10) Pub. No.: US 2012/0047573 A1
(43) Pub. Date: Feb. 23, 2012

(54) METHODS AND APPARATUS FOR DETECTING INVALID IPV6 PACKETS

(76) Inventors: RICHARD JEREMY DUNCAN, Fairfax, VA (US); Ronald Scott Hulen, Ashburn, VA (US)

(21) Appl. No.: 12/857,771

(22) Filed: Aug. 17, 2010

(51) Int. Cl. G06F 17/00; H04L 12/56

(52) U.S. Cl. 726/13; 370/392

(57) ABSTRACT

In one embodiment, a non-transitory processor-readable medium stores code representing instructions to cause a processor to determine (1) whether an IPv6 packet includes an extension header of an illegal type and (2) a quantity of extension headers present in the IPv6 packet that are of a preselected type. When the IPv6 packet includes the extension header of the illegal type, the code can send a first signal to block transmission of the IPv6 packet. When the quantity of extension headers that are of the preselected type is greater than a preselected quantity, the code can send a second signal to block transmission of the IPv6 packet.

### CROSS-REFERENCE TO RELATED APPLICATIONS

This application is related to co-pending U.S. Non-provisional Patent Applications bearing Attorney Docket Nos. COMM-003/00US and COMM-004/00US, each filed on the same date, and entitled “Decapsulation of Data Packet Tunnels to Process Encapsulated IPv4 or IPv6 Packets” and “Systems and Methods for Detecting Preselected Query Type within a DNS Query,” respectively, both of which are incorporated herein by reference in their entirety.

### BACKGROUND

Some embodiments described herein relate generally to the inspection and filtering of data packets, and more particularly to methods and apparatus for the inspection and filtering of Internet Protocol version 6 (IPv6) data packets based on packet header and/or extension header properties and/or values.

Known network protection and packet-filtering solutions perform analysis and inspection of incoming network communications so as to detect potentially malicious data packets. Known solutions fail to account for many vulnerabilities inherent in the headers and extension headers of IPv6 data packets, however. Among these are vulnerabilities associated with hop-by-hop, routing options and destination options headers. Thus, a need exists for methods and apparatus to inspect incoming network data for potential threats included in the headers and/or extension headers of incoming IPv6 data packets.

### SUMMARY

In one embodiment, a non-transitory processor-readable medium stores code representing instructions to cause a processor to determine (1) whether an IPv6 packet includes an extension header of an illegal type and (2) a quantity of extension headers present in the IPv6 packet that are of a preselected type. When the IPv6 packet includes the extension header of the illegal type, the code can send a first signal to block transmission of the IPv6 packet. When the quantity of extension headers that are of the preselected type is greater than a preselected quantity, the code can send a second signal to block transmission of the IPv6 packet.

### BRIEF DESCRIPTION OF THE DRAWINGS

FIG. 1 is a schematic diagram that illustrates a packet filtering system, according to an embodiment.

FIG. 2 is a schematic diagram that illustrates a packet inspection unit, according to an embodiment.

FIG. 3 is a flow chart that illustrates a method of filtering an IPv6 packet based on one or more filter policies associated with the IPv6 packet header, according to an embodiment.

FIG. 4 is a flow chart that illustrates a method of filtering an IPv6 packet based on the presence or absence of an illegal header type and a quantity of extension headers of a preselected type, according to an embodiment.

FIG. 5 is a flow chart that illustrates a method of filtering an IPv6 packet based on a quantity of destination headers of the IPv6 packet and a quantity of consecutive octet pads included therein, according to an embodiment.

FIG. 6 is a flow chart that illustrates a method of filtering an IPv6 packet based on an illegal payload length, according to a embodiment.

FIG. 7 is a schematic diagram that illustrates an example of an IPv6 packet including an IPv6 header, a set of IPv6 extension headers and an IPv6 payload.

FIG. 8 is a schematic diagram that illustrates an example of a set of IPv6 extension headers.

FIG. 9 is a schematic diagram that illustrates an example of an IPv6 destination options extension header.

### DETAILED DESCRIPTION

In some embodiments, a gateway device located on the ingress side of a client network can receive an IPv6 packet containing a packet header and one or more IPv6 extension headers. The gateway device can be operatively and/or physically coupled to both an external network and one or more packet inspection units configured to inspect and apply filter policies to incoming data packets received via the external network. In some embodiments, the gateway device can be further physically and/or operatively coupled to a policy unit configured to define and transmit such filter policies for translation by the gateway device and use by the one or more packet inspection units. In some embodiments, the gateway device can be operatively and/or physically coupled to a reporting and analysis unit configured to perform analysis on allowed and/or blocked data packets in individual instances and/or in aggregate. In some embodiments, the one or more packet inspection units can be operatively and/or physically coupled to one or more devices included in a client network, such as a local area network (LAN). In some embodiments, the one or more packet inspection units can be included in a single device.

Each packet inspection unit can be, for example, a hardware-based and/or software-based module or device configured to inspect incoming data packets for one or more IPv6 header and/or extension header vulnerabilities. In some embodiments, the packet inspection unit can inspect a header and/or payload of an incoming data packet. The packet inspection unit can optionally be configured to inspect successive levels or layers of tunneled packets included in an incoming IPv4 or IPv6 data packet, as discussed in related application COMM-003/00US, filed on the same date, and entitled “Decapsulation of IPv4/UDP Tunnels to Process IPv6 Packets,” which is incorporated by reference herein. In some embodiments, the packet inspection unit can receive one or more filter policies from the gateway device and/or the policy unit described above. In such embodiments, the packet inspection unit can apply one or more such filter policies subsequent to or as part of the packet inspection process. After applying the one or more filter policies, the packet inspection unit can next determine whether the inspected data packet should be blocked from access to the client network, allowed into the client network, or sent for further processing and analysis by another module or device within or outside the packet inspection unit.

In some embodiments, a packet inspection unit can detect the presence of one or more extension headers included in an incoming IPv6 packet. For example, in some embodiments a packet inspection unit can detect the presence of a hop-by-hop, routing options, destination options and/or a Internet Control Message Protocol Version 6 (ICMPv6) extension header included in the incoming IPv6 packet. (For an example of an IPv6 destination options extension header, see FIG. 9.) In some embodiments, the packet inspection unit can apply one or more filter policies to determine whether any of the included extension headers is improperly formed or constructed, or includes an illegal or out-of-bounds value. In some embodiments, a filter policy can dictate that the incoming IPv6 packet should be blocked upon detection of an improperly formed extension header an/or illegal header value. In some embodiments, a filter policy can dictate that the incoming IPv6 packet should be allowed into the client network if no improperly formed header or illegal header value is found in the incoming IPv6 packet. In some embodiments, a filter policy can dictate that the incoming IPv6 packet should be sent for further IPv6 processing if no improperly formed extension header or illegal header value is found in the incoming IPv6 packet.

For example, in some embodiments, a filter policy can dictate that an incoming IPv6 packet should be blocked upon detection of more than one hop-by-hop headers within the extension header chain of the incoming IPv6 packet. The filter policy can further dictate that the incoming IPv6 packet should be blocked if it includes a hop-by-hop header with two or more consecutive pads.

In some embodiments, a filter policy can dictate that an incoming IPv6 packet should be blocked upon detection of more than one routing options header within the extension header chain of the incoming IPv6 packet. In some embodiments, the filter policy can dictate that an incoming IPv6 packet should be blocked upon detection of more than one destination options header within the extension header chain of the incoming IPv6 packet. The filter policy can further dictate that the incoming IPv6 packet should be blocked if it includes destination options header with two or more consecutive pads.

In some embodiments, a filter policy can dictate that an incoming IPv6 packet should be blocked upon detection of an illegal payload length within the incoming IPv6 packet.

In some embodiments, the policy unit can include a user interface that allows an individual, such as a network administrator, to define one or more filter policies for application by the one or more packet inspection units. In such embodiments, the policy unit can include a web interface. In some embodiments, the reporting and analysis unit can include a web and/or other interface configured to allow an individual, such as a network or system administrator, to generate one or more logs, reports, charts, graphs or other formatted data associated with the history of incoming data packets received and filtered by the gateway device and one or more packet inspection units.

As used in this specification, the singular forms “a,” “an” and “the” include plural referents unless the context clearly dictates otherwise. Thus, for example, the term “a module” is intended to mean a single module or a combination of modules.

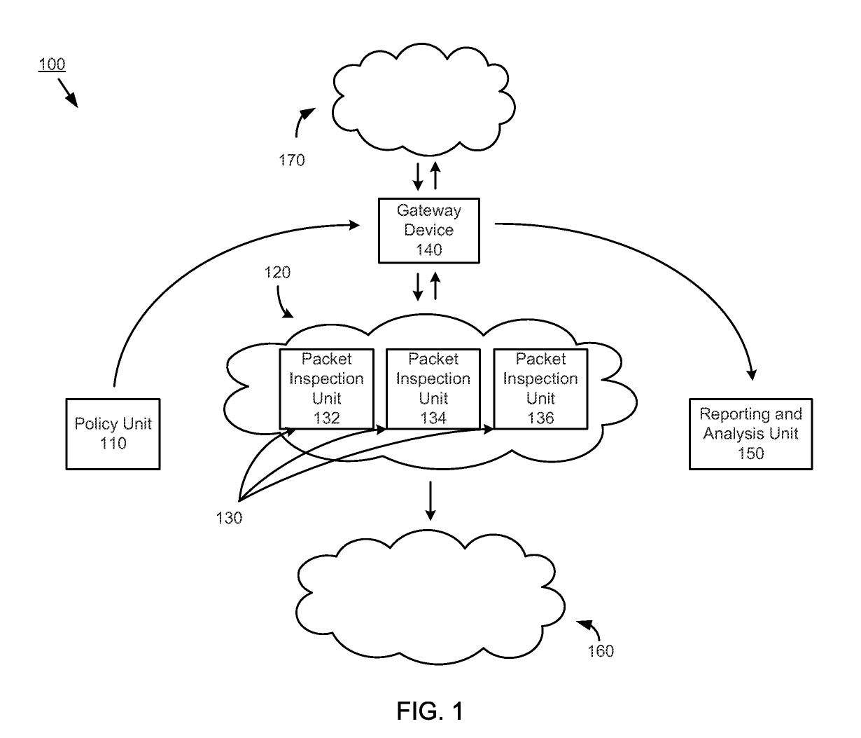

FIG. 1 is a schematic diagram that illustrates a packet filtering system, according to an embodiment. More specifically, FIG. 1 illustrates Packet Filtering System 100. The Packet Filtering System 100 includes Packet Inspection Unit 132, Packet Inspection Unit 134 and Packet Inspection Unit 136 (collectively referred to as Packet Inspection Units 130) included in a Packet Inspection Network 120 and each in communication with a Gateway Device 140 and a Client Network 160. The Gateway Device 140 is in further communication with a Policy Unit 110, a Reporting and Analysis Unit 150 and an External Network 170.

The Policy Unit 110 can be any combination of hardware and/or software (executing on hardware) configured to transmit one or more filter policies to one or more of the Packet Inspection Units 130. In some embodiments, the Policy Unit 110 can be operatively and/or physically coupled to the Gateway Device 140. For example, the Policy Unit 110 can be coupled to the Gateway Device 140 via a wired and/or wireless data connection, such as a wired Ethernet connection, a wireless 802.11x (“Wi-Fi”) connection, etc. In some embodiments, the Policy Unit 110 can be one of multiple such policy units included in the Packet Filtering System 100. The Policy Unit 110 can optionally be or can be disposed within a server device (not shown in FIG. 1). In some embodiments, the Policy Unit 110 can be included in the same hardware device as the Gateway Device 140 and/or one or more of the Packet Inspection Units 130.

The Policy Unit 110 can optionally include a web-based interface that enables an administrator or other user of the Packet Filtering System 100 to create, define, clone, import or export filter policies or other policies, rules, instructions or directives. In some embodiments, the Policy Unit 110 can transmit a filter policy to the Gateway Device 140. The filter policy can include one or more rules that define when various packets or packet types are to be allowed into the Packet Inspection Network 120, blocked therefrom, or sent for further processing before being ultimately allowed or blocked from the Packet Inspection Network 120. In some embodiments, the Policy Unit 110 can include one or more default filter policies.

The Packet Inspection Network 120 can be comprised of one or more packet inspection units, such as the Packet Inspection Units 130. In some embodiments, the Packet Inspection Network can include one or more switching and/or routing devices configured to direct network traffic (i.e., incoming data packets) received from the Gateway Device 140 to and/or between the Packet Inspection Units 130. In some embodiments, the one or more switching and/or routing devices can be configured to direct network traffic (including, e.g., filter results) from the Packet Inspection Units 130 to the Gateway Device 140. In some embodiments, the Packet Inspection Units 130 can be in communication with one another so as to send and receive incoming data packets within the Packet Inspection Network 120. In some embodiments, the Packet Inspection Units 130 can be in communication for load-balancing purposes. For example, in some embodiments, the Packet Inspection Unit 122 can be in communication with the Packet Inspection Unit 124 and the Packet Inspection Unit 126 so that when the Packet Inspection Unit 122 receives an incoming data packet, the Packet Inspection Unit 122 can send the incoming data packet to at least one of the Packet Inspection Unit 124 and the Packet Inspection Unit 126 for handling if the Packet Inspection Unit 122 is currently operating at or past a threshold level of activity.

The Packet Inspection Units 130 can each be any combination of hardware and/or software (executing on hardware) configured to apply one or more filter policies to one or more incoming data packets (not shown in FIG. 1). In some embodiments both the filter policies and incoming data packets can be received at the Packet Inspection Units via the Gateway Device 140. In some embodiments, the Packet Inspection Units 130 can each be configured to apply one or more filter policies to an incoming data packet to determine whether that data packet should be forwarded onto or permitted to be accessed by one or more other devices included in the Client Network 160. The Packet Inspection Units 130 can thus prevent potentially malicious data packets from reaching devices within the Client Network 160, and thereby thwart security breaches and/or other remote attacks. In some embodiments, the Packet Inspection Units 130 can include one or more hardware and/or software modules, such as third-party modules configured to inspect and/or apply filter policies or rules on incoming data packets.

In some embodiments, one or more of the Packet Inspection Units 130 can be a server computing device operatively and/or physically coupled to the Gateway Device 140. For example, the Packet Inspection Unit 134 can be coupled to the Gateway Device 140 via a wired and/or wireless data connection, such as a wired Ethernet connection, a wireless 802.11x (“Wi-Fi”) connection, and/or a WiMax, Ultra-wideband (UWB), Universal Serial Bus (USB), Bluetooth, infrared, cellular network, or other wireless data connection. In some embodiments, the Packet Inspection Unit 134 can be in communication with the Gateway Device 140 via one or more switching and/or routing devices (not shown) included in the Packet Inspection Network 120. In some embodiments, one or more of the Packet Inspection Units 130 can be included in a single device. In some embodiments, one or more of the Packet Inspection Units 130 can be included in the same hardware device as the Gateway Device 140, the Policy Unit 110 and/or the Reporting and Analysis Unit 150. Alternatively, one or more of the Packet Inspection Units 130 can be disposed within separate or distinct devices from one another and/or from the Gateway Device 140, the Policy Unit 110 and/or the Reporting and Analysis Unit 150. In some embodiments, the Packet Filtering System 100 can include any number of packet inspection units sufficient to perform filtering on all or a portion of incoming data packets received at, for example, the Gateway Device 140.

In some embodiments, the Gateway Device 140 can be any combination of hardware and/or software (executing on hardware) configured to act as a central point of exchange for incoming data packets and/or filter policies within the Packet Filtering System 100. As shown in FIG. 1, the Gateway Device 140 can exchange information with the External Network 170 and the Packet Inspection Units 130, receive information from the Policy Unit 110 and transmit information to the Reporting and Analysis Unit 150. For example, in some embodiments the Gateway Device 140 can receive one or more incoming data packets from the External Network 170, and one or more filter policies from the Policy Unit 110. In such embodiments, the Gateway Device 140 can transmit the one or more incoming data packets received from the External Network 170 to one or more of the Packet Inspection Units 130 for application of filter polices and/or rules. In some embodiments, the Gateway Device 140 can be further configured to receive filter results and/or events from one or more of the Packet Inspection Units 130. The Gateway Device 140 can additionally transmit information associated with filter results and/or events to the Reporting and Analysis Unit 150. Although not shown in FIG. 1, in some embodiments the Gateway Device 140 can transmit information to the Policy Unit 110 and/or receive information from the Reporting and Analysis Unit 150.

In some embodiments, the Gateway Device 140 can be a hardware device, such as a server device operatively and/or physically coupled to the Policy Unit 110. In some embodiments, the Gateway Device 140 can include or comprise one or more devices included in the Packet Filtering System 100 (such as the Policy Unit 110, one or more of the Packet Inspection Units 130 and/or the Reporting and Analysis Unit 150). In some embodiments, the Gateway Device 140 can be or be included in a single hardware device, and/or be included in a single or multiple hardware devices along with one or more of the Policy Unit 110, one or more of the Packet Inspection Units 130 and/or the Reporting and Analysis Unit 150. In some embodiments, the Gateway Device 140 can be one of multiple such gateway devices included on the periphery of the Client Network 160, the gateway devices being configured to provide routing and/or other administrative functionality for the Client Network 160. In some embodiments, the Gateway Device 140 can be coupled to one or more of the above-mentioned devices via one or more wired and/or wireless data connections, such as connections conforming to one or more known information exchange standards, such as wired Ethernet, wireless 802.11x (“Wi-Fi”), WiMax, Ultra-wideband (UWB), Universal Serial Bus (USB), Bluetooth, infrared, Code Division Multiple Access (CDMA), Time Division Multiple Access (TDMA), Global Systems for Mobile Communications (GSM), Long Term Evolution (LTE), and the like.

The Reporting and Analysis Unit 150 can be any combination of hardware and/or software (executing on hardware) configured to receive information associated with filter results and/or events from the Gateway Device 140 and provide reporting and analysis to a user and/or administrator of the Packet Filtering System 100. For example, the Reporting and Analysis Unit 150 can provide, via a text, graphical and/or web-based interface, reporting information associated with block and/or allow decisions made by the Packet Inspection Units 130 on incoming data packets. In some embodiments, the reporting and analysis can include aggregated trend information in the form of charts, graphs and the like. In some embodiments, the reporting and analysis can include alert and/or other information designed to notify a user of a particular filtering or network traffic event, such as a suspected attack or atypical amount or type of incoming traffic.

The Client Network 160 can be any computing network. For example, the Client Network 160 can be a local area network (LAN), wide area network (WAN), virtual local area network (VLAN), intranet, or extranet. In some embodiments, the Client Network 160 can include one or more of: switching and/or routing devices, server and/or client devices, peripheral devices, mobile computing devices, telephony devices, and the like. As shown in FIG. 1, one or more devices included in the Client Network 160 (not shown in FIG. 1) can receive one or more filtered data packets from any of the Packet Inspection Units 130.

In some embodiments, the Policy Unit 110 can receive, via user input, information sufficient to define one or more filter policies. For example, the Policy Unit 110 can receive user input that defines a filter policy stipulating that incoming data packets with improperly formed headers and/or excessively tunneled payloads should be blocked.

Upon receipt and/or definition of a filter policy, the Policy Unit 110 can transmit information associated with the filter policy to the Gateway Device 140. In some embodiments, the Policy Unit 110 can transmit the information according to a preselected or predefined policy update schedule. Alternatively or additionally, in some embodiments, the Policy Unit 110 can transmit the information associated with the new filter policy immediately, or after a specified delay period.

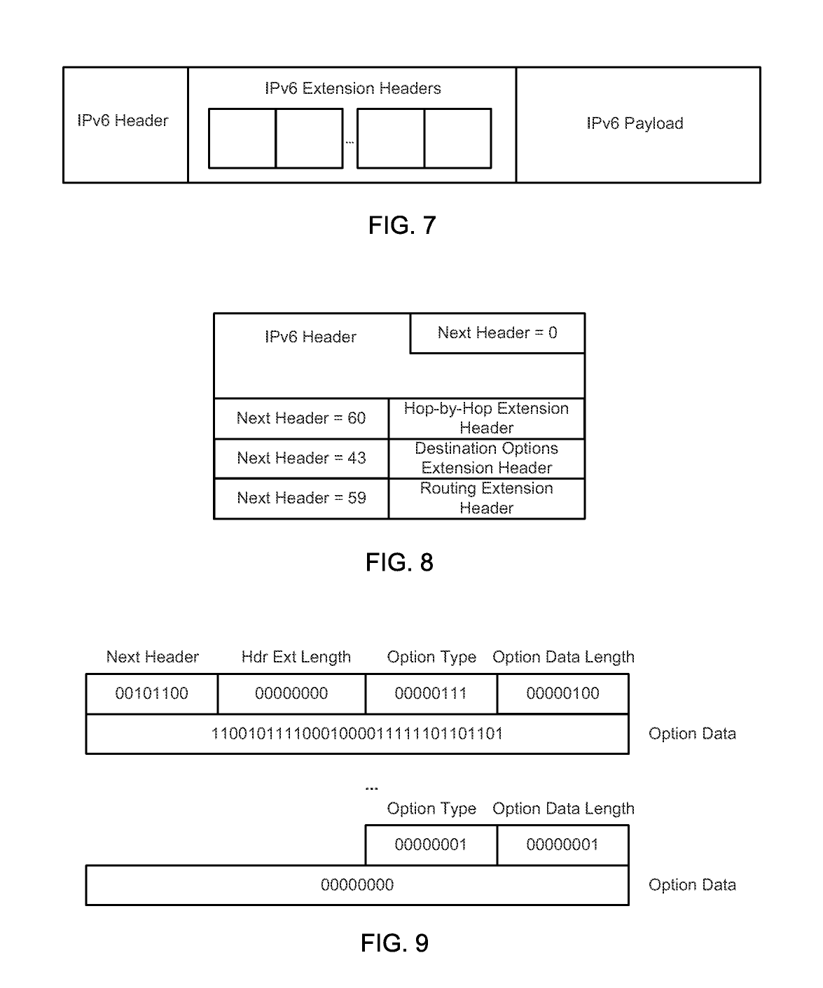

Upon receipt of the filter policy information, the Gateway Device 140 can translate the filter policy into a format and/or set of one or more commands that can be interpreted and applied by the Packet Inspection Units 130. In some embodiments, the Gateway Device 140 can then transmit the translated filter policy information to the Packet Inspection Units 130 for use in filtering incoming data packets. In some embodiments, the Gateway Device 140 can also receive one or more incoming data packets from the External Network 170 and forward at least one of the incoming data packets to, for example, the Packet Inspection Unit 136. Each incoming data packet can be, for example, an Internet Protocol version 4 (IPv4) or Internet Protocol version 6 (IPv6) data packet. (For an example of an IPv6 data packet, see FIG. 7.)

In some embodiments, the Packet Inspection Unit 136 (or any of the Packet Inspection Units 130) can receive the translated filter policy information from the Gateway Device 140. In such embodiments, the Packet Inspection Unit 136 can then receive at least a portion of an incoming data packet from the Gateway Device 140 and apply one or more rules derived from the translated filter policy information to the incoming data packet. For example, in some embodiments the Packet Inspection Unit 136 can analyze a header and/or a payload of the incoming data packet and determine whether or not the incoming data packet meets or violates the one or more rules included in or derived from the translated filter policy information. In some embodiments, the Packet Inspection Unit 136 can detect one or illegal or improperly formed IPv6 extension headers. (For an example of a set of IPv6 extension headers, see FIG. 8.) In such embodiments, the Packet Inspection Unit 136 can apply the one or more rules on at least a portion of the incoming data packet, such as a header and/or extension headers of the incoming data packet, or, optionally, a tunneled packet included in the payload of the incoming data packet.

Upon completion of the analysis, the Packet Inspection Unit 136 can transmit a filter result and/or event to the Gateway Device 140. The filter result can indicate, for example, whether the incoming data packet has satisfied a set of conditions specified by the filter policy described above. For example, the filter result can indicate whether the incoming data packet met or failed to meet particular conditions stipulated by the filter policy. In some embodiments, the filter result can include an instruction based at least in part on the analysis, such as an instruction for the Gateway Device 140 to block at least a portion of the incoming data packet from entering the Packet Inspection Network 120. In some embodiments, the Packet Inspection Unit 136 can transmit the filter result upon completion of the analysis, after a preselected or calculated delay period, or along with one or more other filter results after a preselected quantity of filter results have been calculated.

In some embodiments, the Gateway Device 140 can receive the filter result from the Packet Inspection Unit 136 and take action responsive thereto. For example, if the Gateway Device 140 receives a filter result indicating a failed rule condition and/or indicating a block action, the Gateway Device 140 can block the incoming data packet from entering the Packet Inspection Network 120. In some embodiments, the Gateway Device 140 can block a first portion of the incoming data packet and allow a second portion of the incoming data packet to enter the Packet Inspection Network 120 via one or more network devices (not shown in FIG. 1).

The Gateway Device 140 can additionally be configured to transmit an indication of the filter result and/or the action taken responsive thereto to the Reporting and Analysis Unit 150. In some embodiments, the Gateway Device 140 can transmit the indication upon receipt of the filter result, after having taken the responsive action described above, in accordance with a preselected or predefined schedule, upon receipt of a threshold number of filter results, and/or upon receipt of a threshold number of positive or negative filter results.

In some embodiments, the Reporting and Analysis Unit 150 can receive the indication of the filter result and include it in a log or other record associated with the Packet Filtering System 100. For example, the Reporting and Analysis Unit 150 can store the indication and/or information associated with and/or derived from the indication at a memory, such as a database (not shown in FIG. 1) included in and/or physically or operatively coupled to the Reporting and Analysis Unit 150. In some embodiments, the Reporting and Analysis Unit 150 can perform one or more analyses and/or generate one or more reports, charts and/or graphs based at least in part on the indication. In such embodiments, the Reporting and Analysis Unit 150 can provide an interface, such as a web-based interface, whereby a user of the Packet Filtering System 100 can access information associated with the indication and/or the analysis and reporting information based thereon as described above.

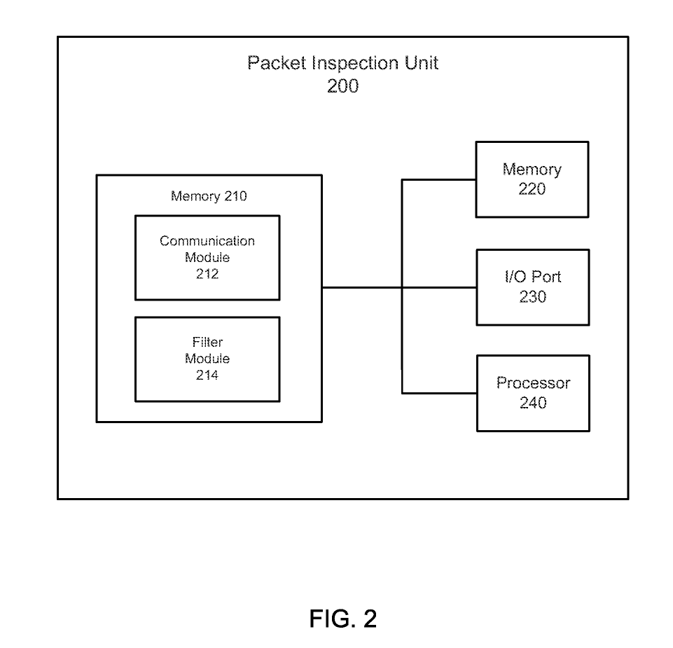

FIG. 2 is a schematic diagram that illustrates a packet inspection unit, according to an embodiment. More specifically, FIG. 2 illustrates Packet Inspection Unit 200 including a Memory 210, a Memory 220, an Input/Output (“I/O”) Port 230 and a Processor 240. The Memory 210 includes a Communication Module 212 and a Filter Module 214. As shown in FIG. 2, each of the Communication Module 212 and the Filter Module 214 can be in communication with each of the Memory 220, the I/O Port 230 and/or the Processor 240. As also shown in FIG. 2, each of the Memory 220, the I/O Port 230 and the Processor 240 can be in communication with one another.

The Packet Inspection Unit 200 can be any combination of hardware components and/or devices configured to receive and apply filter policies to incoming data packets. For example, in some embodiments the Packet Inspection Unit 200 can be a hardware device, such as a server device or system included in, in communication with and/or connected to a network, (not shown in FIG. 2), such as a LAN, a WAN, an extranet, intranet, or the Internet. The Packet Inspection Unit 200 can optionally be configured to receive one or more incoming data packets from a network device (not shown in FIG. 2) and apply one or more filter policies thereon. In some embodiments, the Packet Inspection Unit 200 can store the one or more filter policies in a memory, such as the Filter Module 214 included in the Memory 210. In some embodiments, the Packet Inspection Unit 200 can receive one or more filter policies from another device, such as a gateway device as discussed in connection with FIG. 1 above.

The Memory 210 can be any valid memory, such as, for example, a read-only memory (ROM) or a random-access memory (RAM). In some embodiments, the Memory 210 can be, for example, any type of processor-readable media, such as a hard-disk drive, a compact disc read-only memory (CD-ROM), a digital video disc (DVD), a Blu-ray disc, a flash memory card, or other portable digital memory type. The Memory 210 can optionally be configured to send signals to and receive signals from the Memory 220, the I/O Port 230, and/or the Processor 240.

The Communication Module 212 can be any valid combination of hardware and/or software (executing on hardware) configured to transmit and receive data packet, filter policy and/or filter result information. In some embodiments, the Communication Module 212 can exchange data packet, filter policy and/or filter result information with the Filter Module 214. In some embodiments, the Communication Module 212 can receive incoming data packet and filter policy information from, and transmit filter result information to, the I/O Port 230.

The Filter Module 214 can be any valid combination of hardware and/or software (executing on hardware) configured to inspect one or more incoming data packets and apply one or more filter policies thereon. In some embodiments, the Filter Module 214 can exchange data packet, filter policy and/or filter result information with the Communication Module 212.

In some embodiments, the functionality performed by the Filter Module 214 can optionally be performed by two distinct modules, such as an inspection module (not shown in FIG. 2) and a filter module. In such embodiments, the inspection module can inspect an incoming data packet or data packet portion, to identify characteristics of the incoming data packet or data packet portion, such as header length, header contents, payload length, payload contents, one or more protocols specified by the data packet header, the presence or absence of encapsulated packets in the data packet payload, etc. In some embodiments, the inspection module can inspect a header and/or one or more IPv6 extension headers of the incoming data packet or data packet portion to determine, for example, whether the header and/or IPv6 extension headers are well-formed, malformed, and/or include potentially malicious information. (For an example of a set of IPv6 extension headers, see FIG. 8.) In such embodiments, the filter module can apply one or more filter policies to the inspected data packet or data packet portion to make a block or allow determination.

The Memory 220 can be any valid memory, such as, for example, a read-only memory (ROM) or a random-access memory (RAM). In some embodiments, the Memory 220 can be, for example, any type of processor-readable media, such as a hard-disk drive, a compact disc read-only memory (CD-ROM), a digital video disc (DVD), a Blu-ray disc, a flash memory card, or other portable digital memory type. The Memory 220 can optionally be configured to send signals to and receive signals from the Memory 210, the I/O Port 230, and/or the Processor 240.

The I/O Port 230 can be any valid combination of hardware and/or software (executing on hardware) configured to receive information at and transmit data from the Packet Inspection Unit 200. In some embodiments, the I/O Port 230 can be a hardware network communication device and/or a software module configured to format and transmit data to and from the hardware communication device. For example, in some embodiments, the I/O Port 230 can include network interface card (NIC), such as a wired and/or wireless Ethernet card, and an associated software device driver. As shown in FIG. 2, the I/O Port 230 can also transmit signals to and receive signals from the Memory 210, the Memory 220 and/or the Processor 240.

The Processor 240 can be any valid hardware processor configured to execute instructions, such as computing instructions included in and/or defined by the Communication Module 212 and/or the Filter Module 214. The Processor 240 can be, for example, an application-specific integrated circuit (ASIC), a digital signal processor (DSP), a field programmable gate array (FPGA), etc. As shown in FIG. 2, the Processor 240 can transmit signals to and receive signals from the Memory 210, the Memory 220 and/or the I/O Port 230. In some embodiments, the Processor 240 can access computing instructions in the Memory 220 for execution at the Processor 240 and then transmit information, including computed results, to the Memory 220.

In some embodiments, the I/O Port 230 can receive at least one filter policy from, for example, a policy unit and/or gateway device as discussed in connection with FIG. 1 above. The I/O Port 230 can then transmit the filter policy to the Communication Module 212 for subsequent transmission to the Filter Module 214. In some embodiments, the Filter Module 214 can already include one or more filter policies, the filter policies having been loaded at a previous time, such as during an initial device setup and/or software installation.

In some embodiments, the I/O Port 230 can receive at least one incoming data packet from, for example, a gateway device (as discussed in connection with FIG. 1 above). The I/O Port 230 can then transmit the incoming data packet to the Filter Module 214 via the Communication Module 212. In some embodiments, the incoming data packet can be, for example, an IPv4 packet, an IPv6 packet, or other known data packet type. (For an example of an IPv6 packet, see FIG. 7.) The incoming data packet can contain a header and/or a payload as required by its data packet type or definition. For example, when the incoming data packet is an IPv4 data packet, the incoming data packet can include a variable-length header and a variable-length payload. The payload can optionally include data, such as application data and/or a tunneled (i.e., encapsulated packet).

The Filter Module 214 can next determine whether one or more conditions specified by a given filter policy are satisfied by the incoming data packet or a portion of the incoming data packet. In some embodiments, the Filter Module 214 can then apply the filter policy to determine whether the data packet or data packet portion should be allowed into the client network, blocked from the client network, or sent to another module or device for further processing. In some embodiments, the Filter Module 214 can determine that a portion of the incoming data packet, such as a payload of the incoming data packet, should be sent to another portion of code included in the Filter Module 214 for further processing. In some embodiments, the Filter Module 214 can inspect a header of an incoming IPv6 packet and/or one or more extension headers of the incoming IPv6 packet. For example, in some embodiments, the Filter Module 214 can determine whether a quantity of extension headers present in the IPv6 packet that are of a preselected type exceeds a first preselected number, such as one. In some embodiments, the Filter Module 214 can determine whether at least one extension header of the IPv6 packet includes a quantity of consecutive octet pads that exceeds a second preselected quantity, such as one. In some embodiments, the Filter Module 214 can determine whether a payload of the IPv6 packet has an illegal length. In some embodiments, the Filter Module can apply one or more filter policies to and/or based on one or more of the above described determinations to make a block, allow, or further-processing determination (i.e., a filter result).

In such embodiments, the Filter Module 214 can then transmit, via the Communication Module 212 and the I/O Port 230, a filter result associated with the determination. The filter result can include, for example, an indication that the data packet or data packet portion did or did not satisfy all requirements of a filter policy applied thereto or thereon. In some embodiments, the filter result can include an indication that the incoming data packet or incoming data packet portion should be allowed into the client network, should not be allowed into the network, or should be sent for further packet filtering and/or processing. In such embodiments, the filter result can include an “allow,” “block,” or “further processing” indicator configured or formatted to instruct a device, such as a gateway device, to accordingly allow or block the incoming data packet or incoming data packet portion.

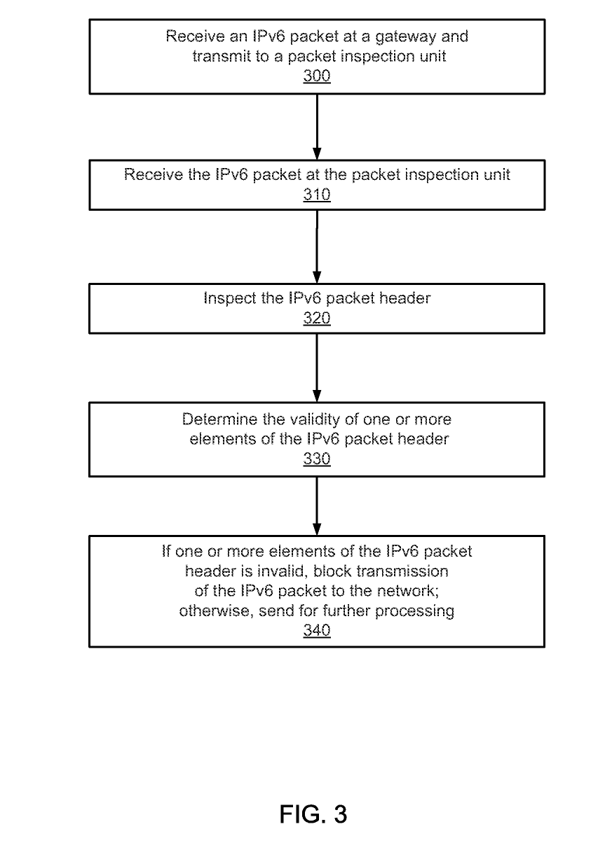

FIG. 3 is a flow chart that illustrates a method of filtering an IPv6 packet based on one or more filter policies associated with the IPv6 packet header, according to an embodiment. More specifically, FIG. 3 illustrates a method of applying one or more filter policies to a set of IPv6 extension headers included in an IPv6 packet.

As shown in FIG. 3, an IPv6 packet can be received at a gateway device and transmitted thereby to a packet inspection unit, at 300. (For an example of an IPv6 packet, see FIG. 7.) In some embodiments, the IPv6 packet can be an incoming data packet formatted and defined according to the IPv6 specification (as defined by Internet Engineering Task Force (IETF) Request for Comment (RFC) 2460). In such embodiments, the IPv6 packet can include a header and a payload, the header including packet addressing and other information and one or more extension headers. The gateway device can be, for example, a network gateway device (e.g., Gateway Device 140 as discussed in connection with FIG. 1 above) situated on the periphery of a computer network, such as a LAN, VLAN, WAN, intranet or extranet (e.g., External Network 170 as discussed in connection with FIG. 1 above). The packet inspection unit (e.g., Packet Inspection Unit 122 as discussed in connection with FIG. 1 above) can be, for example, a hardware-based device that includes software (executing on hardware) configured to inspect and apply filter policies on incoming data packets. In some embodiments, the gateway device can send the IPv6 packet to the packet inspection unit via a wired or wireless connection or link, such as a wired Ethernet or wireless Ethernet (802.11x, or “Wi-Fi”) connection.

The packet inspection unit can receive the IPv6 packet, at 310. In some embodiments, the packet inspection unit can include one or more hardware modules and/or one or more software modules (executing in hardware) configured to receive incoming data packet and/or filter policy information from another device or module. For example, the packet inspection unit can include a network interface card (NIC) and/or one or more software modules to transmit data to and from the NIC.

The packet inspection unit can inspect a header of the IPv6 packet, at 320. More specifically, the packet inspection unit can inspect a header of the IPv6 packet and one or more extension headers included in the IPv6 packet. For example, the packet inspection unit can determine a length of the header of the IPv6 packet, a number of extension headers included in the IPv6 packet, the source and/or destination address information included in the header of the IPv6 packet, etc. In some embodiments, the packet inspection unit can determine, for example, whether the IPv6 packet includes more than one hop-by-hop, routing options, destination options and/or ICMPv6 header. (For an example of an IPv6 destination options extension header, see FIG. 9.) In some embodiments, the packet inspection unit can determine whether the IPv6 packet includes a hop-by-hop and/or destination options header with more than a preselected quantity of consecutive pads, such as two.

The packet inspection unit can apply one or more filter policies on or to the IPv6 header and extension headers to determine the validity of one or more elements of the IPv6 packet, at 330. For example, the packet inspection unit can apply a filter policy concerned with the presence of more than one hop-by-hop, routing options and/or destination options header within the extension headers of the IPv6 packet. If the packet inspection unit determines that the extension headers of the IPv6 packet include more than one hop-by-hop header, more than one routing options header and/or more than one destination options header, the packet inspection unit can conclude that the IPv6 packet is invalid.

In some embodiments, the packet inspection unit can apply a filter policy concerned with the presence of a preselected number of consecutive pads included in a hop-by-hop and/or destination options header within the IPv6 packet. If the packet inspection unit determines that the extension headers of the IPv6 packet include more than the preselected number of consecutive pads, such as two consecutive pads, the packet inspection unit can conclude that the IPv6 packet is invalid.

The packet inspection unit can next take appropriate action based on the conclusion reached in 330 above, at 340. More specifically, the packet inspection unit can send a signal to block the IPv6 packet if it has determined that the IPv6 packet should be blocked as discussed in connection with step 330 above. In some embodiments, the signal can be sent within the packet inspection unit such that the packet inspection unit blocks the IPv6 packet. The packet inspection unit can allow the IPv6 packet if it has determined that the IPv6 packet should be allowed as discussed in connection with step 330 above. In some embodiments, when allowing an IPv6 packet, the packet inspection unit can remove a header of the IPv6 packet, transmitting only the payload of the IPv6 packet to, for example, the gateway device discussed above. Alternatively, in some embodiments the packet inspection unit can transmit to the gateway device a signal indicating the block or allow determination, and the gateway device can then perform the indicated action on the IPv6 packet. As described above, in some embodiments the packet inspection unit can transmit all or a portion of the IPv6 packet to an IPv6 processing module (not shown) for further processing. In some embodiments, the IPv6 processing module can be a separate software-based module (executing in hardware) and/or hardware-based module or device running software configured to further inspect, analyze, examine and/or filter a received data packet or data packet portion. In some embodiments, the IPv6 processing module can be included on or physically or operatively coupled to the packet inspection unit.

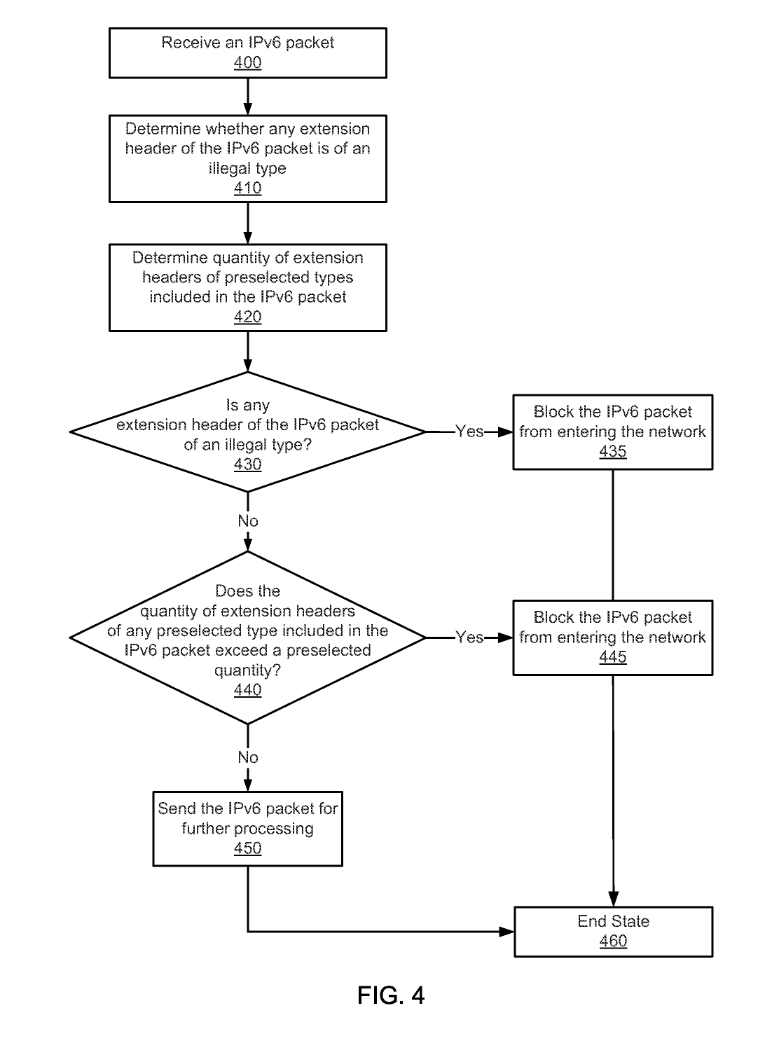

FIG. 4 is a flow chart that illustrates a method of filtering an IPv6 packet based on the presence or absence of an illegal header type and a quantity of extension headers of a preselected type, according to an embodiment. (For an example of a set of IPv6 extension headers, see FIG. 8.) As shown in FIG. 4, an IPv6 packet can be received, at 400. In some embodiments, the IPv6 packet can be an incoming data packet formatted and defined according to the IPv6 specification (as defined by IETF RFC 2460). In such embodiments, the IPv6 packet can include a header and a payload, the header including packet addressing and other information and one or more extension headers. In some embodiments, the IPv6 packet can be received at a gateway device via an external network and transmitted thereby to a packet inspection unit. The gateway device can be, for example, a network gateway device (e.g., Gateway Device 140 as discussed in connection with FIG. 1 above) situated on the periphery of a computer network, such as a LAN, VLAN, WAN, intranet or extranet. The packet inspection unit (e.g., Packet Inspection Unit 122 as discussed in connection with FIG. 1 above) can be, for example, a hardware-based device that includes software (executing on hardware) configured to inspect and apply filter policies on incoming data packets. In some embodiments, the gateway device can send the IPv6 packet to the packet inspection unit via a wired or wireless connection or link, such as a wired Ethernet or wireless Ethernet (802.11x, or “Wi-Fi”) connection.

The packet inspection unit can determine whether any extension header of the IPv6 packet is of an illegal type, at 410. In some embodiments, the packet inspection unit can inspect each extension header included in the IPv6 packet and determine whether that extension header fails to match legal IPv6 extension header types or definitions. If the packet inspection unit determines that any inspected extension header of the IPv6 packet is of an illegal type, the packet inspection unit can conclude that the IPv6 packet includes an illegal extension header.

The packet inspection unit can next determine whether a quantity of extension headers of one or more preselected types is included in the IPv6 packet, at 420. In some embodiments the packet inspection unit can inspect each extension header of the IPv6 packet and maintain a counter associated with each preselected type. For example, the packet inspection unit can, for each extension header of the IPv6 packet, identify the type of that extension header and then increment the counter associated with the identified type. In some embodiments, the preselected types can include, for example, a hop-by-hop extension header type, a routing options extension header type and/or a destination options extension header type.

The packet inspection unit can take one of two actions based on the presence or absence of an extension header of an illegal type within the IPv6 packet, at 430. As shown in FIG. 4, if the packet inspection unit has concluded in 410 that the IPv6 packet includes an illegal extension header, the packet inspection unit can determine that the IPv6 packet should be blocked, and proceed to step 435 discussed below. Alternatively, if the packet inspection unit has concluded in 410 that the IPv6 packet does not include an illegal extension header, the packet inspection unit can proceed to step 440 discussed below.

If the packet inspection unit has determined that the IPv6 packet should be blocked, it can send a signal to block the IPv6 packet from entering the network, at 435. In some embodiments, the signal can be sent within the packet inspection unit such that the IPv6 packet is blocked. In some embodiments, the packet inspection unit can alternatively send a signal to the gateway device indicating that the IPv6 packet should be blocked. In such embodiments, the gateway device can block the IPv6 packet in response to the received signal. Having completed processing on the IPv6 packet, the packet inspection unit can proceed to an end state, at 460.

If the packet inspection unit determines that the IPv6 packet does not include an extension header of an illegal type, the packet inspection unit can determine whether the quantity of extension headers of any preselected type as determined in 420 exceeds a preselected quantity, at 440. For example, in some embodiments the packet inspection unit can compare each counter discussed in connection with step 420 above to a preselected quantity, such as one. In such embodiments, if any of the counters associated with the various preselected types exceeds the preselected quantity, the packet inspection unit can conclude that the IPv6 packet should be blocked. Having reached this conclusion, the packet inspection unit can proceed to step 445, discussed below. Alternatively, if the packet inspection unit concludes that none of the counters associated with the various preselected types exceeds the preselected quantity, the packet inspection unit can conclude that the IPv6 packet should not be blocked, and proceed to step 450, discussed below.

If the packet inspection unit determines that the IPv6 packet should be blocked, it can send a signal to block the IPv6 packet from entering the network, at 445. In some embodiments, the packet inspection unit can alternatively send a signal to the gateway device indicating that the IPv6 packet should be blocked, and the gateway device can accordingly block the IPv6 packet in response to the received signal. Having completed processing on the IPv6 packet, the packet inspection unit can proceed to the end state, at 460.

If the packet inspection unit has concluded in 440 that the IPv6 packet does not include a quantity of extension headers of a preselected type that exceeds a preselected quantity, it can send the IPv6 packet for further processing, at 450. In some embodiments, the further processing can include the application of additional filter policies and/or rules on the IPv6 packet and/or other known packet-processing operations. In some embodiments, the packet inspection unit can send the IPv6 packet to another software-based module (executing in hardware) and/or hardware-based module (not shown in FIG. 4) where the further processing can be performed. In some embodiments, the software-based module (executing in hardware) and/or hardware-based module can be included in the packet inspection unit, and/or at or on another device in the network, such as the gateway device or other network device.

Having sent the IPv6 packet for further processing and thus completed its processing thereof, the packet inspection unit can proceed to the end state, at 460.

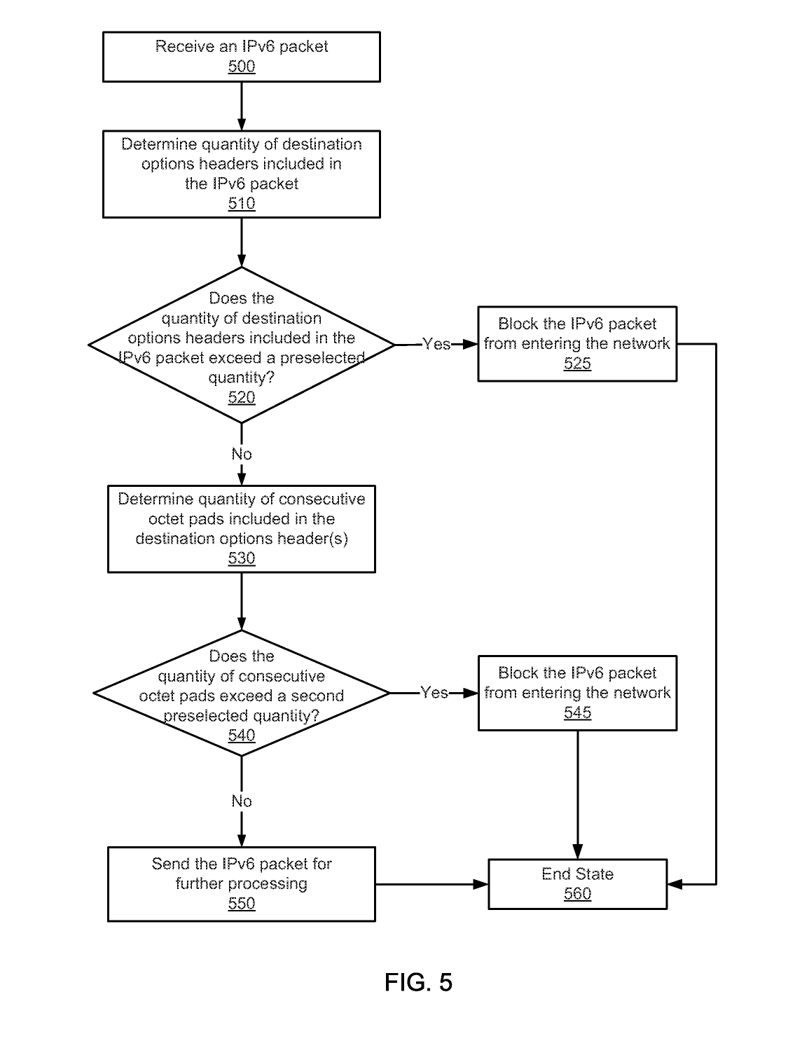

FIG. 5 is a flow chart that illustrates a method of filtering an IPv6 packet based on a quantity of destination headers of the IPv6 packet and a quantity of consecutive octet pads included therein, according to an embodiment. (For an example of a destination options header including multiple consecutive octet pads, see FIG. 9.)

As shown in FIG. 5, an IPv6 packet can be received, at 500. In some embodiments, the IPv6 packet can be an incoming data packet formatted and defined according to the IPv6 specification (as defined by IETF RFC 2460). In such embodiments, the IPv6 packet can include a header and a payload, the header including packet addressing and other information and one or more extension headers. In some embodiments, the IPv6 packet can be received at a gateway device and transmitted thereby to a packet inspection unit. The gateway device can be, for example, a network gateway device (e.g., Gateway Device 140 as discussed in connection with FIG. 1 above) situated on the periphery of a computer network, such as a LAN, VLAN, WAN, intranet or extranet. The packet inspection unit (e.g., Packet Inspection Unit 122 as discussed in connection with FIG. 1 above) can be, for example, a hardware-based device that includes software (executing on hardware) configured to inspect and apply filter policies on incoming data packets. In some embodiments, the gateway device can send the IPv6 packet to the packet inspection unit via a wired or wireless connection or link, such as a wired Ethernet or wireless Ethernet (802.11x, or “Wi-Fi”) connection.

The packet inspection unit can determine a quantity of destination options headers included in the IPv6 packet, at 510. In some embodiments, the packet inspection unit can inspect each extension header of the IPv6 packet and maintain a counter of discovered destination options headers. For example, the packet inspection unit can, for each extension header of the IPv6 packet, identify the type of that extension header, and increment the counter if that extension header is a destination options header.

The packet inspection unit can take one of two actions based on the quantity of destination options headers included in the IPv6 packet, at 520. In some embodiments, the packet inspection unit can determine whether the quantity of destination options headers of the IPv6 packet exceeds a preselected quantity. For example, the packet inspection unit can compare the counter discussed in connection with step 510 above to a preselected quantity, such as one. If the counter exceeds the preselected quantity, the packet inspection unit can conclude that the IPv6 packet should be blocked from the network.

If the packet inspection unit determines that the IPv6 packet should be blocked, it can block the IPv6 packet from entering the network, at 525. In some embodiments, the packet inspection unit can alternatively send a signal to the gateway device indicating that the IPv6 packet should be blocked. Having completed processing on the IPv6 packet, the packet inspection unit can proceed to an end state, at 560.

If the packet inspection unit determines that the quantity of destination options headers does not exceed the preselected quantity, the packet inspection unit can determine a quantity of consecutive octet pads present in the destination options headers of the IPv6 packet, at 530. For example, in some embodiments, the packet inspection unit can inspect each identified destination options header of the IPv6 packet and determine the number of consecutive octet pads included in that destination options header. In some embodiments, the packet inspection unit can maintain a consecutive octet counter associated with each destination options header of the IPv6 packet.

The packet inspection unit can take one of two actions based on whether the quantity of consecutive octet pads present in one or more of the destination options headers of the IPv6 packet exceeds a second preselected quantity, at 540. In some embodiments, the packet inspection unit can determine whether the quantity of any of the consecutive octet counters discussed in connection with step 530 exceeds a second preselected quantity. For example, the packet inspection unit can compare each of the consecutive octet counters to a second preselected quantity, such as one. If any of the consecutive octet counters exceeds the second preselected quantity, the packet inspection unit can conclude that the IPv6 packet should be blocked from the network.

If the packet inspection unit determines that the IPv6 packet should be blocked, it can send a signal to block the IPv6 packet from entering the network, at 545. In some embodiments, the packet inspection unit can alternatively send a signal to the gateway device indicating that the IPv6 packet should be blocked, and the gateway device can accordingly block the IPv6 packet in response to the received signal. Having completed processing on the IPv6 packet, the packet inspection unit can proceed to the end state, at 560.

If the packet inspection unit determines that the IPv6 packet does not include more than the second preselected quantity of consecutive octet pads, the packet inspection unit can send the IPv6 packet to an IPv6 processing module (not shown in FIG. 5) for further processing, at 550. In some embodiments, the further processing can include the application of additional filter policies and/or rules on the IPv6 packet and/or other known packet-processing operations. In some embodiments, the packet inspection unit can send the IPv6 packet to another software-based and/or hardware-based module where the further processing can be performed. In some embodiments, the software-based and/or hardware-based module can be included in the packet inspection unit, and/or at or on another device in the network, such as the gateway device or other network device.

Having sent the IPv6 packet for further processing and thus completed its processing thereof, the packet inspection unit can proceed to the end state, at 560.

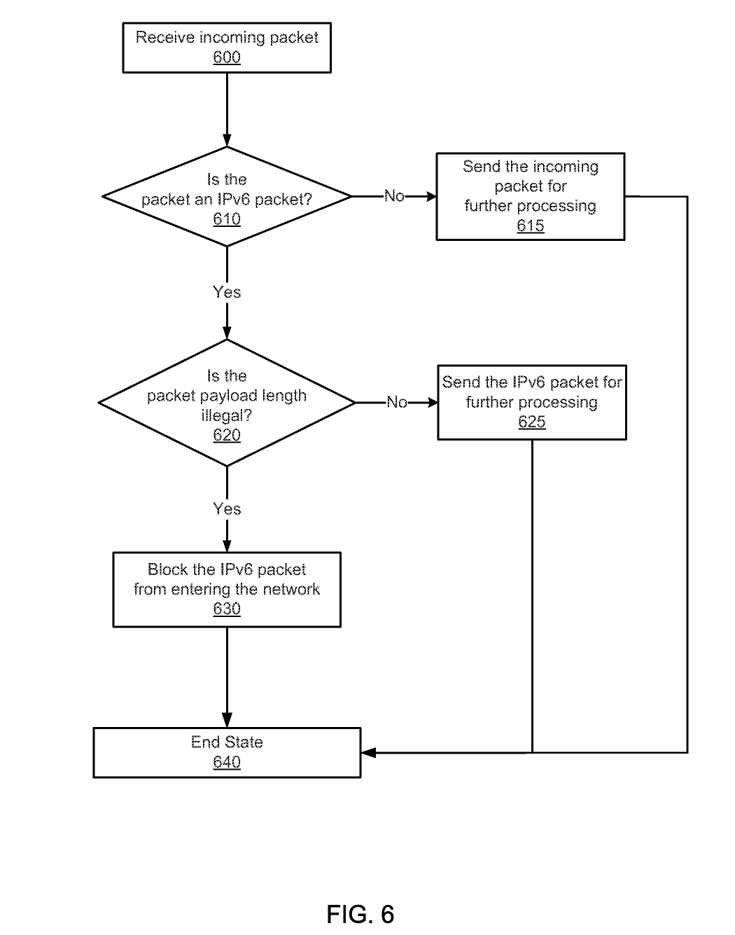

FIG. 6 is a flow chart that illustrates a method of filtering an incoming packet based on an illegal payload length, according to a embodiment. More specifically, FIG. 6 illustrates a method of filtering an incoming packet based on: (1) whether the incoming packet is an IPv6 packet and (2) whether the incoming packet has an illegal payload length.

As shown in FIG. 6, an incoming packet can be received, at 600. In some embodiments, the incoming packet can include a header and a payload, the header including packet addressing and other information and one or more extension headers. In some embodiments, the incoming packet can be received at a gateway device and transmitted thereby to a packet inspection unit. The gateway device can be, for example, a network gateway device (e.g., Gateway Device 140 as discussed in connection with FIG. 1 above) situated on the periphery of a computer network, such as a LAN, VLAN, WAN, intranet or extranet. The packet inspection unit (e.g., Packet Inspection Unit 122 as discussed in connection with FIG. 1 above) can be, for example, a hardware-based device that includes software (executing on hardware) configured to inspect and apply filter policies on incoming data packets. In some embodiments, the gateway device can send the incoming packet to the packet inspection unit via a wired or wireless connection or link, such as a wired Ethernet or wireless Ethernet (802.11x, or “Wi-Fi”) connection.

The packet inspection unit can determine whether the incoming packet is an IPv6 packet, at 610. To do so, the packet inspection unit can, for example, determine whether the packet conforms to packet formatting and content requirements specified by IETF RFC 2460. For example, the packet inspection unit can determine whether a version field included in a header of the packet has a preselected value of six.

If the packet inspection unit concludes that the incoming packet is not an IPv6 packet, it can send the incoming packet for further processing, at 615. In some embodiments, the further processing can include the application of additional filter policies and/or rules on the incoming packet and/or other known packet-processing operations. In some embodiments, the packet inspection unit can send the incoming packet to another software-based module (executing in hardware) and/or hardware-based module (not shown in FIG. 6) where the further processing can be performed. In some embodiments, the software-based module (executing in hardware) and/or hardware-based module can be included in the packet inspection unit, and/or at or on another device in the network, such as the gateway device or other network device. Having completed processing on the IPv6 packet, the packet inspection unit can proceed to an end state, at 640.

If the packet inspection unit concludes that the incoming packet is an IPv6 packet, the packet inspection unit can determine if the packet has an illegal payload length, at 620. For example, in some embodiments the packet inspection unit can determine a start location of the incoming packet payload based at least in part on a length of the incoming (IPv6) packet header and a total length of one or more extension headers of the incoming packet. The packet inspection unit can next determine the length of the payload of the incoming packet by calculating a number of bytes and/or bits included from the start location of the payload to the end location of the payload. In some embodiments, the packet inspection unit can conclude that the payload length is illegal if it fails to fall within a preselected legal range. For example, in some embodiments, the packet inspection unit can conclude that the payload length is illegal if the payload length is less than 10 bytes or greater than 8000 bytes. If the packet inspection unit concludes that the length of the payload of the incoming packet is not illegal, it can send the IPv6 packet for further processing, at 625. In some embodiments, the further processing can be similar to the further processing described in connection with step 615 above, and/or include additional processing and/or operations specifically tailored to the processing of IPv6 packets. Having completed processing on the IPv6 packet, the packet inspection unit can proceed to the end state, at 640.

If the packet inspection unit determines that the length of the payload of the incoming packet is illegal, it can send a signal to block the incoming (IPv6) packet from the network, at 630. In some embodiments, the packet inspection unit can alternatively send a signal to the gateway device indicating that the IPv6 packet should be blocked, and the gateway device can accordingly block the IPv6 packet in response to the received signal. Having completed processing on the IPv6 packet, the packet inspection unit can proceed to the end state, at 640.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments a tunneled packet filtering system can include two or more gateway devices similar to the Gateway Device 140 discussed in connection with FIG. 1 above.

What is claimed is:

1. A non-transitory processor-readable medium storing code representing instructions to cause a processor to:
determine whether an IPv6 packet includes an extension header of an illegal type;
determine a quantity of extension headers present in the IPv6 packet that are of a preselected type;
send a first signal to block transmission of the IPv6 packet when the IPv6 packet includes the extension header of the illegal type; and
send a second signal to block transmission of the IPv6 packet when the quantity of extension headers that are of the preselected type is greater than a preselected quantity.

2. The non-transitory processor-readable medium of claim 1, wherein the preselected type is one of:
a hop-by-hop extension header type;
a routing options extension header type; or a destination options extension header type.

3. The non-transitory processor-readable medium of claim 1, wherein the preselected quantity is two.

4. The non-transitory processor-readable medium of claim 1, wherein the code to determine includes code to examine a set of one or more Next Header values included in the IPv6 packet, each Next Header value from the set of one or more Next Header values including information associated with an extension header included in the IPv6 packet.

5. A non-transitory processor-readable medium storing code representing instructions to cause a processor to:
determine a number of destination options headers present in an IPv6 packet;
determine whether a first destination options header included in the IPv6 packet includes a preselected number of consecutive octet pads;
send a first signal to block transmission of the IPv6 packet when the number of destination options headers is greater than one; and
send a second signal to block transmission of the IPv6 packet when the first destination options header includes more than the preselected number of consecutive octet pads.

6. The non-transitory processor-readable medium of claim 5, wherein the first destination options header is included in a set of one or more IPv6 extension headers.

7. The non-transitory processor-readable medium of claim 5, wherein the preselected number of consecutive octet pads is two.

8. The non-transitory processor-readable medium of claim 5, wherein the preselected number of octet pads is a first preselected number of octet pads, the code further comprising code to:
determine whether a hop-by-hop header included in the IPv6 packet includes a second preselected number of consecutive octet pads; and
send a third signal to block transmission of the IPv6 packet when the hop-by-hop header includes more than the second preselected number of consecutive octet pads.

9. A non-transitory processor-readable medium storing code representing instructions to cause a processor to:
determine whether a packet is an IPv6 packet;
determine whether a length of a payload within the packet is illegal; and
send a signal to block transmission of the packet when the packet is an IPv6 packet and the length of the payload is illegal.

10. The non-transitory processor-readable medium of claim 9, wherein the length of the payload is illegal when the length of the payload is less than 10 bytes or greater than 8000 bytes.

11. An apparatus, comprising:
a communication module, the communication module configured to receive an IPv4 packet; and
a filter module, the filter module configured to:
determine at least one of the following: (1) whether a number of extension headers present in an IPv6 packet that are of a preselected type exceeds a first preselected number, (2) whether at least one extension header present in the IPv6 packet includes a number of consecutive octet pads that exceeds a second preselected number, or (3) whether a payload within the IPv6 packet has an illegal length, to produce a determination result; and
send a signal to block transmission of the IPv6 packet when the determination result is positive.

12. The apparatus of claim 11, wherein the preselected type is one of:
a hop-by-hop extension header type;
a routing options extension header type; or
a destination options extension header type.

13. The apparatus of claim 11, wherein the second preselected number is two.

14. The apparatus of claim 11, wherein the filter module is configured to examine a set of one or more Next Header values included in the IPv6 packet to determine the number of extension headers.

15. The apparatus of claim 11, wherein the first preselected number is two.
